(19) United States
(12) Patent Application Publication
(10) Pub. No.: US 2024/0334413 A1
(43) Pub. Date: Oct. 3, 2024

(54) BANDWIDTH PART AND SUB-BAND RESOURCE INDICATION AND DETERMINATION FOR WIRELESS COMMUNICATIONS

(71) Applicant: ZTE Corporation, Shenzhen (CN)

(72) Inventors: Shuaihua KOU, Shenzhen (CN); Wei GOU, Shenzhen (CN); Xing LIU, Shenzhen (CN); Xianghui HAN, Shenzhen (CN); Xingguang WEI, Shenzhen (CN)

(73) Assignee: ZTE Corporation, Shenzhen (CN)

(21) Appl. No.: 18/680,575

(22) Filed: May 31, 2024

Related U.S. Application Data
(63) Continuation of application No. PCT/CN2022/116788, filed on Sep. 2, 2022.

(51) Int. Cl. H04W 72/0453; H04B 1/713; H04W 72/232

(52) U.S. Cl. CPC H04W 72/0453; H04B 1/713; H04W 72/232

(57) ABSTRACT

This document generally relates to wireless communication that includes a user device and a wireless access node that determine a first frequency range for an uplink (UL) bandwidth part (BWP) and a second frequency range for an UL sub-band. The user device and/or the wireless access node determine a frequency hopping offset value or a frequency resource for a physical uplink shared channel (PUSCH) based on at least one of the first frequency range or the second frequency range. The user device transmits, and the wireless access node receives, the PUSCH on the UL BWP or the UL sub-band.

### CROSS-REFERENCE TO RELATED APPLICATION(S)

This application is a continuation of International Patent Application No. PCT/CN2022/116788, filed Sep. 2, 2022. The contents of International Patent Application No. PCT/CN2022/116788 are herein incorporated by reference in their entirety.

### TECHNICAL FIELD

This document is directed generally to determining and indicating resources for bandwidth parts and sub-bands for wireless communication.

### BACKGROUND

In wireless communication systems, resources are divided into downlink resources and uplink resources in a time-division multiplexed (TDM) manner for time-division duplex systems. Downlink transmissions may only be transmitted on the downlink resources and uplink transmissions may only be transmitted on the uplink resources. If the network has downlink data to be transmitted, it cannot transmit the downlink data until the downlink resources are available, and vice versa. This, in turn, may cause latency, which may be too large in some cases, such as to satisfy services with high latency requirements, e.g., an ultra-reliable low latency communications (URLLC) service. Ways to reduce latency while avoiding issues such as interference between uplink and downlink transmissions, and/or while optimally determining resources for uplink and downlink transmissions, may be desirable.

### SUMMARY

This document relates to methods, systems, apparatuses and devices for wireless communication. In some implementations, a method for wireless communication includes: determining, with a wireless access node, a first frequency range for an uplink (UL) bandwidth part (BWP), and a second frequency range for an UL sub-band; determining, with the wireless access node, a frequency hopping offset value or a frequency resource for a physical uplink shared channel (PUSCH) based on at least one of the first frequency range or the second frequency range; and receiving, with the wireless access node, the physical uplink shared channel (PUSCH) on the UL BWP or on the UL sub-band.

In some other implementations, a method for wireless communication includes: determining, with a user device, a first frequency range for an uplink (UL) bandwidth part (BWP), and a second frequency range for an UL sub-band; determining, with the user device, a frequency hopping offset value or a frequency resource for a physical uplink shared channel (PUSCH) based on at least one of the first frequency range or the second frequency range; and transmitting, with the user device, the PUSCH on the UL BWP or on the UL sub-band.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows an example method for wireless communication that relates to bandwidth parts and sub-bands.

FIG. 3 shows another example method for wireless communication that relates to bandwidth parts and sub-bands.

### DETAILED DESCRIPTION

The present description describes various embodiments of systems, apparatuses, devices, and methods for wireless communications bandwidth part (BWP) and sub-band resource indication and determination.

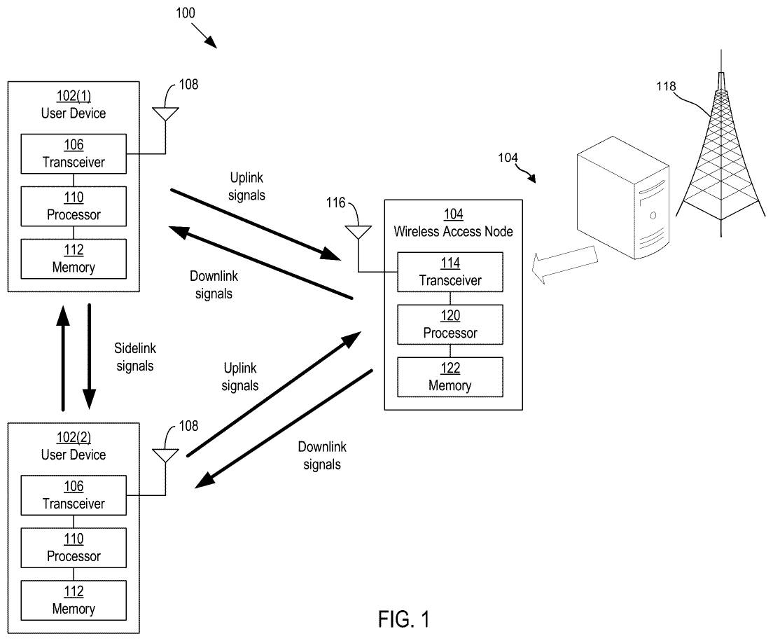

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise at least one of: a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In addition, referring back to FIG. 1, in various embodiments, two communication nodes in the wireless system 100-such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system in 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

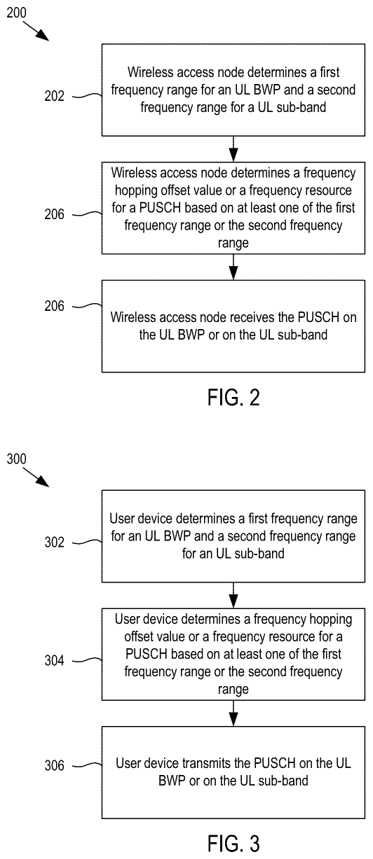

FIG. 2 shows a flow chart of an example method 200 related to uplink (UL) bandwidth parts (BWP) and UL sub-bands. At block 202, the wireless access node 104 may determine a first frequency range for an UL BWP and a second frequency range for an UL sub-band. At block 204, the wireless access node 104 may determine a frequency hopping offset value or a frequency resource for a PUSCH based on at least one of the first frequency range or the second frequency range. At block 206, the wireless access node 104 may receive the PUSCH on the UL BWP or on the UL sub-band.

FIG. 3 shows a flow chart of an example method 300 related to UL BWPs and UL sub-bands. At block 302, a user device 102 may determine a first frequency range for an UL BWP and a second frequency range for an UL sub-band. At block 304, the user device 102 may determine a frequency hopping offset value or a frequency resource for a PUSCH based on at least one of the first frequency range or the second frequency range. At block 306, the user device 102 may transmit the PUSCH on the UL BWP or on the UL sub-band.

In further detail, in wireless communication system 100, the wireless access node 104 (e.g., the network) may configure a slot as a downlink slot, an uplink slot or a flexible slot. In addition or alternatively, the wireless access node 104 may configure a symbol as a downlink symbol, an uplink symbol or a flexible symbol. A downlink slot or symbol is a slot or symbol designated for one or more downlink (DL) transmissions. An uplink slot or symbol is a lot or symbol designated for one or more uplink (UL) transmissions. Also, as used herein, the term “flexible” as used for time and/or frequency resources, such as sub-bands, slots, symbols, etc., refers to that the user device 102 may not make any assumptions as to the uplink or downlink transmission direction for that time or frequency resource, or a frame structure is configured/determined for the flexible sub-band. The user device 102 may transmit in the UL direction or receive in the DL direction on or in a given flexible time or frequency resource, depending on any scheduling or other configuration, such as determined by the network device 104.

In addition or alternatively, in some embodiments, the wireless access node 104 may configure an uplink (UL) bandwidth part (BWP). The UL BWP may comprise a first plurality of frequency resources (e.g., a first number of frequency resources). The UL BWP may be on or occupy one or more uplink symbols, uplink slots, flexible symbols, or flexible slots. In addition, the wireless access node 104 may configure a downlink (DL) bandwidth part (BWP). The DL BWP may be on or occupy one or more downlink symbols, downlink slots, flexible symbols, or flexible slots. In addition, the wireless access node 104 may configure an uplink (UL) sub-band. The UL sub-band may comprise a second plurality of frequency resources (e.g., a second number of frequency resources). The UL sub-band may be on or occupy one or more downlink symbols, downlink slot, flexible symbols or flexible slots. Alternatively, the UL sub-band may be within the DL BWP. Also, in any of various embodiments, a frequency resource may include one or more resource elements (e.g., one or more sub-carriers), one or more resource block (RBs), and/or one or more resource block groups (RBGs).

Also, in at least some embodiments, the wireless access node may configure a first hopping method for a PUSCH transmission on the UL sub-band and a second hopping method for the PUSCH transmission on the UL BWP. For at least some embodiments, each of the first hopping method and the second hopping method may include no hopping, intra-slot hopping or inter-slot hopping. For example, the wireless access node 104 may configure no hopping for the PUSCH transmission on the UL sub-band, and may configure inter-slot hopping for the PUSCH transmission on the UL BWP. Correspondingly, in this example, the user device 102 may not perform frequency hopping for the PUSCH when the PUSCH is transmitted on the UL sub-band, and may perform inter-slot hopping for the PUSCH when the PUSCH is transmitted on the UL BWP.

Additionally, in general, frequency hopping is a technology used in wireless communication, where transmissions are divided into multiple parts in the time domain, and each part is transmitted on a frequency. For example, in a NR system, a PUCCH is divided into two parts for intra-frequency hopping. The first part is transmitted on a first plurality of physical resource blocks (PRBs) (or a frequency resource of a first hop). The second part is transmitted on a second plurality of PRBs (or a frequency resource of a second hop). The first plurality of PRBs and the second plurality of PRBs may have the same number of PRBs. Also, the frequency hopping offset is the frequency interval between the first plurality of PRBs and the second plurality of PRBs. The frequency hopping offset value includes the number of the PRBs for the frequency hopping offset. In general, the second plurality of PRBs (or the frequency resource of the second hop) are determined based on the first plurality of PRBs (or the frequency resource of the first hop) and the frequency hopping offset. As an example, suppose that the frequency resource of a first hop is PRB 0 and PRB 1, and the hopping offset is 5 PRBs. Correspondingly, the frequency resource of the second hop is PRB 5 and PRB 6.

In addition, for at least some embodiments, the wireless access node 104 may configure a first plurality of hopping offset values for the PUSCH transmission on the UL sub-band and a second plurality of hopping offset values for the PUSCH transmission on the UL BWP. For example, the wireless access node 104 may configure two hopping offset values for the PUSCH transmission on the UL sub-band and four hopping offset values for the PUSCH transmission on the UL BWP. If a PUSCH is transmitted on the UL sub-band, the DCI may indicate one of the hopping offset values among the first plurality of hopping offset values. In addition, if a PUSCH is transmitted on the UL BWP, the DCI may indicate one of the hopping offset values among the second plurality of hopping offset values. The user device 102 may use the indicated hopping offset value for PUSCH transmission.

Additionally, for at least some embodiments, the frequency resource of the PUSCH transmitted on the UL BWP may be determined based on the first number of the frequency resources. Also, in some embodiments, the frequency resource of the PUSCH transmitted on the UL sub-band may be determined based on the second number of the frequency resources.

In addition or alternatively, in some embodiments, a DCI may include a frequency domain resource allocation (FDRA) field for indicating the frequency resource of a PUSCH transmission. For at least some embodiments, a length of the FDRA field may depend on a number of frequency resources of the UL BWP or UL sub-band (e.g., the first number or the second number). More specifically, in some embodiments, the length of the FDRA field may depend on the larger of the first number and the second number. For example, the FDRA field includes [log₂ N (N+1)/2] bits, where N=max (N1, N2), and N1 is the first number and N2 is the second number. In other embodiments, a first field length (e.g., L1) may be determined based on the UL BWP. For example, L1=[log₂ N1 (N1+1)/2]. Also, a second field length (e.g., L2) may be determined based on the UL sub-band. For example, L2=[log₂ N2 (N2+1)/2]. The length of the FDRA field may be the larger of the first field length and the second field length, e.g., max (L1, L2).

In addition or alternatively, in some embodiments, the FDRA field may indicate the frequency resource for the PUSCH. In turn, the user device 102 may determine the frequency resource according to the FDRA field. In some of these embodiments, the first or the last L1 bits of the FDRA field may indicate the frequency resource of the PUSCH transmitted on the UL BWP. Correspondingly, the user device 102 may use the first or the last L1 bits of the FDRA field to determine the frequency resource of the PUSCH if the PUSCH is scheduled on the UL BWP. Additionally, the bandwidth of UL BWP being larger than the UL sub-band may imply that all of the bits of the FDRA field may indicate the frequency resource of the PUSCH transmitted on the UL BWP. In other of these embodiments, the first or the last L2 bits of the FDRA field may indicate the frequency resource of the PUSCH transmitted on the UL sub-band. Correspondingly, the user device 102 may use the first or the last L2 bits of the FDRA field to determine the frequency resource of the PUSCH if the PUSCH is scheduled on the UL sub-band. The bandwidth of UL sub-band being larger than the UL BWP may imply that all the of bits of the FDRA field may indicate the frequency resource of the PUSCH transmitted on the UL sub-band.

In addition or alternatively, the FDRA field may include two parts, including a first part and a second part. The first part may indicate the frequency hopping offset value. The second part may indicate the frequency resource of the PUSCH before frequency hopping. In some of these embodiments, the first L1 bits of the second part of the FDRA field may indicate the frequency resource of the PUSCH transmitted on the UL BWP. In other of these embodiments, the first L2 bits of the second part of the FDRA field may indicate the frequency resource of the PUSCH transmitted on the UL sub-band.

In some embodiments, in a first case, the first part may include one bit. For embodiments where there are two hopping offset values configured for the UL sub-band or UL BWP, the first part may indicate the hopping offset from among the two hopping offset values. For example, suppose that the two hopping offset values configured for UL sub-band or UL BWP are H1 and H2, respectively. The first part may have a value ‘0’ indicating the first hopping offset (e.g., H1) and the value ‘1’ indicating the second hopping offset (e.g., H2). In addition or alternatively, for embodiments where there are four hopping offset values configured for the UL sub-band or UL BWP, the first part may indicate a hopping offset value from among the first or last two hopping offset values of the four hopping offset values. For example, suppose that the four hopping offset values configured for the UL sub-band or UL BWP are H3, H4, H5 and H6, and that the first two hopping offset values are H3 and H4. The first part may have value ‘0’ indicating the first hopping offset (e.g., H3) and the value ‘1’ indicating the second hopping offset (e.g., H4).

Also, in some embodiments, a frequency hopping flag field in the DCI may indicate whether frequency hopping is performed for the PUSCH. If there are no hopping offset values configured for the UL sub-band or UL BWP, the user device 102 may ignore the first part. In addition or alternatively, the user device 102 may ignore the frequency hopping flag field in the DCI. In addition or alternatively, the user device 102 may not perform frequency hopping for the PUSCH.

Also, in a second case, the first part may include two bits. For embodiments where there are four hopping offset values configured for the UL sub-band or the UL BWP, the first part may indicate the hopping offset value from among the four hopping offset values. For example, the first part may have the value ‘00’ indicating the first hopping offset (e.g., H3), and the value ‘01’ indicating the second hopping offset value (e.g., H4), and so on. Also, for embodiments, where there are two hopping offset values configured for the UL sub-band or the UL BWP, the first bit or the second bit of the first part may indicate the hopping offset value from among the two hopping offset values. The user device 102 may ignore the second bit or the first bit of the first part. For example, the first bit or the second bit of the first part may have the value ‘0’ indicating the first hopping offset (e.g., H1), and the value ‘1’ indicating the second hopping offset (e.g., H2).

Also, for embodiments where there is no hopping offset value configured for the UL sub-band or UL BWP, the user device 102 may ignore the first part. In addition or alternatively, the user device 102 may ignore the frequency hopping flag field in the DCI. In addition or alternatively, the user device 102 may not perform frequency hopping for the PUSCH.

In addition, in a third case, there may be no first part in the FDRA field, which may imply or indicate that the FDRA field does not indicate a hopping offset value. If there are two hopping offset values configured for the UL sub-band or UL BWP, one of the two offset values may be used for the PUSCH transmission on the UL sub-band or UL BWP. For example, the first offset (e.g., H1) of the two hopping offset values is used for the PUSCH transmission on the UL sub-band or UL BWP. If there are four hopping offset values configured for the UL sub-band or UL BWP, one of the four offset values may be used for the PUSCH transmission on the UL sub-band or UL BWP. For example, the first offset value (e.g., H3) of the four hopping offset values is used for the PUSCH transmission on the UL sub-band or UL BWP.

Alternatively, the first bit or the first two bits of the second part of the FDRA field may indicate the hopping offset value from among two hopping offset values or from among four hopping offset values for the PUSCH transmission on the UL BWP or UL sub-band.

In addition or alternatively, in some embodiments, the first part of the FDRA field may indicate the hopping offset value for the PUSCH transmission on the UL BWP and the hopping offset value for the PUSCH transmission on the UL sub-band. For example, each code point of the first part may correspond to a hopping offset value for the PUSCH transmission on the UL BWP and a hopping offset value for the PUSCH transmission on the UL sub-band. The code point of the first part may indicate the corresponding hopping offset. Table 1 below shows an example configuration of a plurality of code point values and corresponding hopping off set values for the UL sub-band and the UL BWP. For example, the code point of the first part of the FDRA field ‘00’ indicates the hopping offset for the PUSCH transmitted on the UL sub-band is H1 and the hopping offset for the PUSCH transmitted on the UL BWP is H3.

TABLE 1
Code point values and corresponding hopping offset
values for the UL sub-band and the UL BWP

| Code point of | Hopping offset for the | Hopping offset for the |
|---|---|---|
| the first part | PUSCH on the UL sub-band | PUSCH on the UL BWP |
| ‘00’ | H1 | H3 |
| ‘01’ | H1 | H4 |
| ‘10’ | H2 | H5 |
| ‘11’ | H2 | H6 |

In some embodiments, the wireless access node 104 network may transmit a DCI to the user device 102. A DCI may schedule a channel. The DCI may include a first field for indicating the resource type of the scheduled channel. The resource type may include the UL sub-band or UL BWP. The channel may include PUSCH, PDSCH, or PUCCH. In particular of these embodiments, a UL DCI may schedule a PUSCH. The first field in the DL DCI may indicate the resource type of the PUSCH. For example, the first field may have a value ‘1’ indicating the resource type of the scheduled PUSCH is the UL BWP, which may imply that the scheduled PUSCH is transmitted on the UL BWP. In addition, the value ‘0’ may indicate that the resource of the scheduled PUSCH is the UL sub-band, which may imply that the scheduled PUSCH is transmitted on the UL sub-band. If the wireless access node 104 schedules the user device 102 to transmit the PUSCH on the flexible slot or symbols, the first field may be set to ‘1’ or ‘0’.

In addition, in some embodiments, the DCI may include a second field for indicating the resource type of the PUCCH. The DL DCI may indicate a PUCCH resource for carrying at least the hybrid automatic repeat request acknowledgement (HARQ-ACK) information of the scheduled PDSCH. The second field may indicate the resource type of the PUCCH. For example, the second field may have a value ‘1’ indicating the resource type of the PUCCH is the UL BWP, which may imply that the PUCCH is transmitted on UL BWP. In addition, the value ‘0’ may indicate that the resource of the PUCCH is UL sub-band, which may imply that the PUCCH is transmitted on the UL sub-band. If the wireless access node 104 schedules the user device 102 to transmit PUCCH on the flexible slot or symbols, the first field may be set to ‘1’ or ‘0’.

In addition, in some embodiments, a DL DCI may schedule a PDSCH. The DL DCI may include a third field for indicating whether there is a UL sub-band in the time domain resource of the scheduled PDSCH. For example, the third field may have a value ‘l’ indicating there is UL sub-band in the time domain resource of the scheduled PDSCH, and a value ‘0’ indicating there is no UL sub-band in the time domain resource of the scheduled PDSCH. If the wireless access node 104 transmits the scheduled PDSCH on the flexible slot or symbols, the third field may be set to ‘1’ or ‘0’.

In addition or alternatively, in some embodiments, the frequency resource of the PUSCH may be determined based on the larger of the UL BWP bandwidth or UL sub-band bandwidth, no matter whether the PUSCH is transmitted on the UL BWP or the UL sub-band. For at least some of these embodiments, the frequency resource of the PUSCH transmitted on the UL sub-band or the UL BWP may be determined based on the UL BWP if the UL BWP has a larger bandwidth than the bandwidth of the UL sub-band, or if the bandwidth of the UL BWP can cover the UL sub-band completely. In addition or alternatively, for a PUSCH, if the frequency resource for the PUSCH transmission on the UL sub-band is out of the UL sub-band, the user device 102 may not transmit the PUSCH. The frequency resource for the PUSCH may include the frequency resource before or after frequency hopping. The PUSCH may include the configured grant (CG) PUSCH or dynamic scheduled PUSCH.

In addition or alternatively, the frequency resource of the PUSCH transmitted on the UL sub-band or UL BWP may be determined based on the UL sub-band if the UL sub-band has a larger bandwidth than the bandwidth of the UL BWP or the bandwidth of the UL sub-band can cover the bandwidth of the UL BWP completely. In addition or alternatively, for a PUSCH, if the frequency resource of the PUSCH transmission on the UL BWP is out of the UL BWP, the user device may not transmit the PUSCH.

In addition or alternatively, in some embodiments, the wireless access node (e.g., the network) 104 may configure PUSCH repetitions for the user device 102. In some of these embodiments, the PUSCH may include K PUSCH repetitions. If the frequency resource of a PUSCH repetition is out of the UL sub-band or the UL BWP, the user device 102 may drop the PUSCH repetition. Dropping a PUSCH repetition may imply that the user device 102 does not transmit the PUSCH repetition. In this case, the slot of the PUSCH repetition or the PUSCH repetition is not counted in the K repetitions. The frequency resource for the PUSCH repetition may include the frequency resource before or after frequency hopping. The PUSCH may include a dynamic grant PUSCH that is scheduled by a DCI or a configured grant PUSCH. Additionally, in various embodiments, the user device 102 may continue to transmit the PUSCH repetitions until all of the K PUSCH repetition are transmitted.

In addition or alternatively, in some embodiments, a PUSCH repetition may cross a boundary of the UL sub-band or the UL BWP in the time domain. The PUSCH repetition may be segmented into one or more actual PUSCH repetitions. For example, the time domain resource of a PUSCH repetition may be 1 slot, i.e., 14 symbols, denoted by symbol 0-13, respectively. In one case, the UL sub-band may occupy the last 7 symbols (e.g., symbol 7-13). There may be no UL BWP or UL sub-band in the first 7 symbols (e.g., symbol 0-6). Therefore, the PUSCH repetition is segmented to an actual PUSCH repetition, where the actual PUSCH repetition occupies the symbols 7-13. In another case, the UL sub-band may occupy the first 5 symbols (e.g., symbol 0-4) and the UL BWP may occupy the last 9 symbols (e.g., symbol 5-14). Then, the PUSCH repetition may be segmented to two actual PUSCH repetitions. The first actual PUSCH repetition may occupy the first 5 symbols (e.g., symbol 0-4) and the second PUSCH repetition may occupy the last 9 symbols (e.g., symbol 5-14).

In addition or alternatively, in some embodiments, the frequency resource of the PUSCH may be determined based on the larger of the UL BWP bandwidth or UL sub-band bandwidth no matter whether the PUSCH is transmitted on the UL BWP or the UL sub-band.

In one case, a first frequency resource may be determined based on the UL BWP. If the PUSCH is transmitted on the UL BWP, the frequency resource of the PUSCH may be the first frequency resource indicated (or determined) by the FDRA field. If the PUSCH is transmitted on the UL sub-band, the frequency resource of the PUSCH may be determined by scaling the first frequency resource according to the UL BWP bandwidth and the UL sub-band bandwidth. For example, the UL BWP bandwidth may include N1 (N1>0) resource blocks (RBs), and the UL sub-band may include N2 (N2>0) RBs. The first frequency resource may start from RB S (S>=0) and occupy O (O>0) RBs. Then the start physical resource block (PRB) of the frequency resource for the PUSCH transmitted on the UL sub-band may be [S*N2/N1] or [S*N2/N1]. The frequency resource for the PUSCH transmitted on the UL sub-band may include [O*N2/N1] or [O*N2/N1] RBs.

In another case, the first frequency resource may be determined based on the UL sub-band. If the PUSCH is transmitted on the UL sub-band, the frequency resource of the PUSCH may be the first frequency resource indicated (or determined) by the FDRA field. If the PUSCH is transmitted on the UL BWP, the frequency resource of the PUSCH is determined by scaling the first frequency resource according to the UL BWP bandwidth and the UL sub-band bandwidth. For example, the start PRB of the frequency resource for the PUSCH transmitted on the UL BWP may be [S*N2/N1] or [S*N2/N1]. The frequency resource for the PUSCH transmitted on the BWP may include [O*N2/N1] or [O*N2/N1] RBs.

In addition or alternatively, in some embodiments, the wireless access node (e.g., the network) 104 may use radio resource control (RRC) signaling to configure a DL transmission or an UL transmission for a user device 102. If the frequency resource of the DL transmission is not in the UL sub-band, the wireless access node 104 may transmit the DL transmission to the user device 102 even though the slot or the symbol of the UL transmission is indicated as a flexible slot or symbol by the DCI. If the frequency resource of the UL transmission is within the UL sub-band, the user device 102 may transmit the UL transmission to the wireless access node 104 even though the slot or the symbol of the UL transmission is indicated as flexible slot or symbol by the DCI.

In addition or alternatively, in some embodiments, a PUSCH may carry UL data including at least a measurement result, e.g. a L3 report. In addition or alternatively, a PUCCH may carry the measurement result, e.g., a L1 report. The measurement result may include at least one of: reference signal received power (RSRP), sounding reference signal-reference signal received power (SRS-RSRP), received signal strength indicator (RSSI), reference signal received quality (RSRQ), or (signal to noise and interference ratio) SINR.

In addition or alternatively, in some embodiments, the wireless access node 104 may configure a plurality of channel state information (CSI) resource groups for the user device 102. Also, the wireless node 104 may configure a plurality of measurement objects for the user device 102. The wireless access node 104 may configure that one of the plurality of CSI resource groups may be associated with one of the plurality of measurement objects. Correspondingly, a given CSI resource group may include a plurality of resources configured in an associated measurement object. Additionally, a measurement object may be associated with more than one CSI resource group, and vice versa. The wireless access node 104 may configure that a CSI resource group may be associated with a CSI report. A CSI resource group may be associated with more than one CSI reports and vice versa.

The user device 102 may measure the configured resources. More specifically, the user device 102 may measure all the plurality of resources included in the CSI resource group. Additionally, the user device 102 may report the measurement result according to the configuration of the CSI report.

A CSI resource group configuration may include at least one of a BWP configuration or a resource type. The BWP configuration may indicate or include the BWP in which the resource included in the CSI resource group is located.

The resource type may include aperiodic, semi-persistent, or periodic. The resource type may imply or indicate that the resources included in the CSI resource group may be aperiodic, semi-persistent, or periodic.

In some embodiments, a CSI report may be configured or specified with a priority. The priority may be determined by at least one of a serving cell index, a CSI report index, a report type, or a report quantity of the CSI report. If a CSI report includes the measurement results for more than one serving cell, the smallest or largest serving cell index of the measurement results may be used for determining the priority for the CSI report. If a CSI report is configured with more than one report quantity, the report quantity that has the highest or lowest priority may be used for determining the priority for the CSI report.

For example, a priority value P for a CSI report may be determined according to: P=2·N_{cells}·Mₛ·y+N_{cells}·Mₛ·k+Mₛ·C+s. Also, the value y may depend on the report type. For example, y=0 for aperiodic CSI reports to be carried on a PUSCH; y=1 for semi-persistent CSI reports to be carried on a PUSCH; y=2 for semi-persistent CSI reports to be carried on a PUCCH; and y=3 for periodic CSI reports to be carried on a PUCCH. Also, the value k depends on the report quantity. In some embodiments, k=0 for CSI reports carrying L1-RSRP, SRS-RSRP, RSSI, RSRQ, or SINR; and k=1 for CSI reports carrying other CSI information. For such embodiments, if a CSI report is configured with report quantities of both RSRP and CQI, then k=0 is used. In other embodiments ‘l’ and ‘0’ values for k may be switched. That is, k=1 for CSI reports carrying L1-RSRP, SRS-RSRP, RSSI, RSRQ, or SINR; and k=0 for CSI reports carrying other CSI information. Also, the parameter c is the serving cell index, N_{cells} is the maximum number of the serving cells that can be configured for the user device 102, the parameter s is the CSI report index, and Mₛ is the maximum number of the CSI reports that can be configured for the user device 102. A first CSI report with a lower priority value has a higher (or, in other embodiments lower) priority than a second CSI report with a higher priority value.

In some embodiments, the wireless access node 104 may configure a plurality of first thresholds for the user device 102. A first threshold may correspond to one or more serving cells. Additionally or alternatively, a first threshold may correspond to one or more measurement objects or one or more CSI reports. More specifically, a first threshold may correspond to one or more resources of a measurement object.

In some embodiments, if a measurement result is larger than or equal to (or, in other embodiments smaller than or equal to) the corresponding first threshold for a specific number of measurement results or for a time interval, then the user device 102 may report the measurement result one or more times. Otherwise, the user device 102 may not report the measurement result. The specific number or the time interval may be configured by the wireless access node 104. For example, suppose the wireless access node 104 configures a first threshold S1 and a number of measurement N1 for the user device 102. If the N1 measurements results are all larger than or equal to the first threshold S1, then the user device 102 may report the measurement results. Otherwise, the user device 102 may not report the measurement results. In another example, the wireless access node 104 configures a first threshold S1, and a time interval Tl for the user device 102. If all of the measurement results during the time interval Tl are larger than or equal to the first threshold S1, then the user device 102 may report the measurement results. Otherwise, the user device 102 may not report the measurement results.

In some embodiments, if a measurement result change (e.g., the difference between two consecutive measurement results or between two measurement results within a time interval) is larger than or equal to (or, in other embodiments, smaller than or equal to) the corresponding first threshold, such as within a time interval, then the user device 102 may report the measurement results one or more times. Otherwise, the user device 102 may not report the measurement. More specifically, if a first measurement result and a second measurement result are within a time interval Tl and the difference between the first measurement result and the second measurement result is larger than or equal to a first threshold S1, then the user device 102 may report the measurement results. Otherwise, the user device 102 may not report the measurement results.

In one embodiment, if the user device 102 reports the measurement results, the user device 102 may first transmit a second MAC CE to the wireless access node 104 before reporting the measurement results. The second MAC CE may be used to request the wireless access node 104 to trigger or activate a corresponding CSI report. If there is no resource to carry the second MAC CE, a scheduling request (SR) may be triggered by the user device 102. The SR may be used to indicate that the second MAC is triggered. A specific SR resource (e.g., a PUCCH resource) may be configured by the wireless access node 104. The user device 102 may transmit the scheduling request on the specific SR resource to the wireless access node 104.

In one embodiment, the wireless access node 104 may configure a plurality of SR resources for the user device 102. Each SR resource may correspond to one or more CSI reports. The SR resource may be used to indicate that user device 102 may report the CSI information for the corresponding CSI reports. If the user device 102 reports the measurement results for a CSI report, the user device 102 may transmit a scheduling request on the corresponding SR resource to the wireless access node 104. If the user device 102 reports the measurement results in more than one CSI report or the measurement results associated with more than one CSI report, the user device 102 may transmit a scheduling request associated with the CSI report with the highest priority on the corresponding SR resource to the wireless access node 104.

In addition or alternatively, in event that a plurality of SR resources overlap with another PUCCH resource for carrying other UCI information in a slot, the SR information may be generated. The generated SR information may be appended to the other UCI information. In particular embodiments, where K SR resources overlap with a PUCCH for carrying other UCI information in a slot, the SR information may be log₂ (k+1) for indicating a negative SR or a positive SR. The negative SR or a positive SR may be indicated in ascending (or descending) order of the SR index. Assuming K=3, the value ‘01’ may indicate that a first SR (or a SR with the smallest SR index) is positive. The value ‘10’ may indicate that a second SR (or a SR with the second smallest SR index) is positive. The value ‘11’ may indicate that a third SR (or a SR with the third smallest SR index) is positive. The value ‘00’ may indicate that all of the K SRs are negative. In some embodiments, the priority of the SR for indicating that the second MAC CE is triggered or that the user device 102 may report the CSI information is higher than the other SR in the slot. Among the K SR, if there is a positive SR for indicating that the second MAC CE is triggered or that the user device 102 may report the CSI information, the SR information should indicate the positive SR.

In some embodiments, the priority of the SR for indicating that the second MAC CE is triggered or the user device 102 may report the CSI information is lower than the SR for a link recovery request but higher than the other SRs in the slot. If there is a positive SR for indicating that the second MAC CE is triggered or the user device 102 may report the CSI information and there is no positive SR for a link recovery request, then the SR information should indicate that the SR is positive for indicating that the second MAC CE is triggered or the user device 102 may report the CSI information.

For example, suppose that there are 5 SR resources in a slot, denoted by SR resource 0, SR resource 2, SR resource 3, SR resource 4, and SR resource 6, respectively. In addition, suppose that SR resource 3 is associated with a CSI report. Correspondingly, SR resource 3 is used for indicating that the user device 102 is to report CSI. Additionally, suppose that SR resource 6 is configured for a link recovery request, and that the length of the SR information is 3 (i.e., [log₂ 6]). In one example, the SR resource 2, SR resource 3 and SR resource 6 are positive and the other SR resources are negative in a slot. Since SR resource 3 is for indicating the user device 102 reports the information, then the SR information is ‘011’ to indicate that the SR resource 3 is positive.

In another example, suppose that the SR resource 2, SR resource 3 and SR resource 6 are positive and the other SR resources are negative in a slot. Since SR resource 6 is for a link recovery request, the SR information is ‘101’ for indicating that the SR resource 6 is positive. In another slot, suppose that the SR resource 2 and SR resource 3 are positive and the other SR resources are negative. Since SR resource 3 is for indicating that the user device 102 reports the CSI information and SR resource 6 for the link recovery request is negative, the SR information is ‘011’ to indicate that the SR resource 3 is positive.

In some embodiments, the wireless access node 104 may configure a plurality of measurement objects for a user device 102. The wireless access node 104 may configure at least a plurality of CSI reports and a plurality of L3 reports for the user device 102. In accordance with the configuration of CSI reports, the user device 102 may report the measurement results by using layer 1 signaling (e.g., UCI) or L2 signaling (e.g., MAC CE). In accordance with the configuration of the L3 reports, the user device 102 may report the measurement results by using layer 3 signaling (e.g., RRC signaling).

In addition or alternatively, the wireless access node 104 may configure that one measurement object may be associated with a CSI report, a L3 report, or both. The wireless access node 104 may configure at least one of a plurality of second thresholds, a plurality of third thresholds, or a plurality of fourth thresholds for the user device 102. A second threshold, a third threshold, or a fourth threshold may correspond to one or more serving cells. Additionally or alternatively, a second threshold, a third threshold, or a fourth threshold may correspond to one or more measurement objects, one or more CSI reports, or one or more L3 reports. More specifically, a second threshold, a third threshold, or a fourth threshold may correspond to one or more resources of a measurement object.

In some embodiments, if a measurement result is larger than or equal to (or, in other embodiments, smaller than or equal to) a corresponding second threshold for a specific number of measurement results or for a time interval, the user device 102 may report the measurement result one or more times in accordance with the configuration of the CSI report. For example, if the specific number of measurement results or all of the measurement results within the time interval are larger than or equal to (or, in other embodiments smaller than or equal to) the corresponding second threshold, the user device 102 may report the measurement results one or more times in accordance with the configuration of the CSI report. This means that the user device 102 may report the measurement result by using UCI (e.g., the measurement result as CSI information) or MAC CE. Otherwise, the user device 102 may report the measurement result one or more times in accordance with the configuration of the L3 report. This means that the user device may report the measurement result by using RRC signaling.

In some embodiments, if a measurement result change (e.g., the difference between two consecutive measurement results or between two measurement results within a time interval) is larger than or equal to (or, in other embodiments, smaller than or equal to) the corresponding second threshold, the user device 102 may report the measurement result one or more times in accordance with the configuration of the CSI report. Otherwise, the user device 102 may report the measurement result one or more times in accordance with the configuration of the L3 report.

In some embodiments, the wireless access node 104 may configure at least one of the third threshold or the fourth threshold. If a measurement result is larger than or equal to (or, or in other embodiments, smaller than or equal to) the corresponding third threshold for a specific number of measurement results or for a time interval, the user device 102 may report the measurement result one or more times in accordance with the configuration of the CSI report, or report the measurement result one or more times in accordance with the configuration of the L3 report. Also, if the measurement result is smaller than or equal to (or, in other embodiments, larger than or equal to) the corresponding third threshold and larger than or equal to (or, in other embodiments, smaller than or equal to) the corresponding fourth threshold, then the user device 102 may report the measurement result one or more times in accordance with the configuration of the L3 report or report the measurement results one or more times in accordance with the configuration of the CSI report. Otherwise, the user device 102 may not report anything.

In some embodiments, if the measurement result change (e.g., the difference between two consecutive measurement results or between two measurement results within a time interval) is larger than or equal to (or, in other embodiments, smaller than or equal to) a corresponding third threshold, then the user device 102 may report the measurement result in accordance with the configuration of the CSI report or report the measurement result one or more times in accordance with the configuration of the L3 report. Else if the measurement result change (e.g., the difference between the two consecutive measurement results or between the two measurement results within a time interval) is smaller than or equal to (or, in other embodiments, larger than or equal to) the corresponding third threshold and larger than or equal to (or, in other embodiments, smaller than or equal to) the corresponding fourth threshold, the user device 102 may report the measurement result one or more times in accordance with the configuration of the L3 report, or report the measurement result one or more times in accordance with the configuration of the CSI report. Otherwise, the user device 102 may not report anything.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present Solution.

The subject matter of the disclosure may also relate to or include, among others, the following aspects:

In a first aspect, a method for wireless communication includes: determining, with a wireless access node, a first frequency range for an uplink (UL) bandwidth part (BWP), and a second frequency range for an UL sub-band; determining, with the wireless access node, a frequency hopping offset value or a frequency resource for a physical uplink shared channel (PUSCH) based on at least one of the first frequency range or the second frequency range; and receiving, with the wireless access node, the physical uplink shared channel (PUSCH) on the UL BWP or on the UL sub-band.

In a second aspect, a method for wireless communication includes: determining, with a user device, a first frequency range for an uplink (UL) bandwidth part (BWP), and a second frequency range for an UL sub-band; determining, with the user device, a frequency hopping offset value or a frequency resource for a physical uplink shared channel (PUSCH) based on at least one of the first frequency range or the second frequency range; and transmitting, with the user device, the PUSCH on the UL BWP or on the UL sub-band.

A third aspect includes any of the first or second aspects, and further includes: determining, with the wireless access node, a first configuration for the first frequency range and a second configuration for the second frequency range, wherein the first configuration and the second configuration each comprise at least one of: a frequency hopping method, a resource block group (RBG) size, or a plurality of frequency hopping offset values.

A fourth aspect includes the third aspect, and further includes wherein the frequency hopping method comprises: no hopping, intra-slot hopping, or inter-slot hopping.

A fifth aspect includes the fourth aspect, and further includes wherein the frequency hopping methods for the first configuration and the second configuration are the same.

A sixth aspect includes the fourth aspect, and further includes wherein the frequency hopping methods for the first configuration and the second configuration are different.

A seventh aspect includes any of the first through sixth aspects, and further includes wherein determining the frequency hopping offset value or the frequency resource for the PUSCH comprises at least one of: determining, with the wireless access node, the hopping offset value from among a plurality of first hopping offset values for the PUSCH when the PUSCH is transmitted on the UL BWP; or determining, with the wireless access node, the hopping offset value from among a plurality of second hopping offset values for the PUSCH when the PUSCH is transmitted on the UL sub-band.

An eighth aspect includes any of the first through seventh aspects, and further includes wherein determining the frequency hopping offset value or the frequency resource for the PUSCH comprises at least one of: determining, with the wireless access node, a first frequency resource for the PUSCH for when the PUSCH is transmitted on the UL BWP based on the first frequency range; or determining, with the wireless access node, a second frequency resource for the PUSCH for when the PUSCH is transmitted on the UL sub-band based on the second frequency range.

A ninth aspect includes any of the first through eighth aspects, and further includes wherein a downlink control information (DCI) comprises a frequency domain resource allocation (FDRA) field that indicates the frequency resource for the PUSCH.

A tenth aspect includes the ninth aspect, and further includes wherein a length of the FDRA field depends on a first number of frequency resources of the UL BWP, on a second number of frequency resources of the UL sub-band, or on a larger of the first number of frequency resources and the second number of frequency resources.

An eleventh aspect includes the ninth aspect, and further includes at least one of: a first or last L1-number of bits of the FDRA field indicates the frequency resource for the PUSCH when the PUSCH is transmitted on the UL BWP; or a first or last L2-number of bits of the FDRA field indicates the frequency resource for the PUSCH for when the PUSCH is transmitted on the UL sub-band.

A twelfth aspect includes the ninth aspect, and further includes wherein the FDRA field further indicates the frequency hopping offset value from among a plurality of first hopping offset values or from among a plurality of second hopping offset values.

A thirteenth aspect includes the twelfth aspect, and further includes wherein the FDRA comprises one bit configured to indicate the frequency hopping offset value from among the plurality of first hopping offset values or the plurality of second hopping offset values.

A fourteenth aspect includes the thirteenth aspect, and further includes wherein the frequency offset value is a from among a first or last two hopping offset values of the plurality of first hopping offset values, or from among a first or last two hopping offset values of the plurality of second hopping offset values.

A fifteenth aspect includes the twelfth aspect, and further includes wherein the FDRA comprises two bits, wherein the two bits are configured to indicate the frequency hopping offset value from among a first or last two hopping offset values of the plurality of first hopping offset values, or from among a first or last two hopping offset values of the plurality of second hopping offset values, wherein one of the first bit or the second bit of the two bits indicates the frequency hopping offset value.

A sixteenth aspect includes the twelfth aspect, and further includes wherein the FDRA comprises two bits, wherein the two bits are configured to indicate the frequency hopping offset value from among a first or last three or four hopping offset values of the plurality of first hopping offset values, or from among a first or last three or four hopping offset values of the plurality of second hopping offset values.

A seventeenth aspect includes the ninth aspect, and further includes wherein the FDRA field indicates no frequency hopping offset value, and a predetermined frequency hopping offset value is used in response to the FDRA field indicating no frequency hopping offset value.

An eighteenth aspect includes the ninth aspect, and further includes wherein at least one of: a first L1-number of bits of the FDRA field, after one or two bits that indicates the frequency hopping offset value, indicates the frequency resource for the PUSCH when the PUSCH is transmitted on the UL BWP; or a first L2-number of bits of the FDRA field, after the one or two bits that indicates the frequency hopping offset value, indicates the frequency resource for the PUSCH when the PUSCH is transmitted on the UL sub-band.

A nineteenth aspect includes the ninth aspect, and further includes: wherein the frequency hopping offset value comprises a first frequency hopping offset value for transmission on the UL BWP and a second hopping offset value for transmission on the UL sub-band, wherein the FDRA field comprises a code point that indicates the first frequency hopping offset value from the among a plurality of first hopping offset values and the second frequency hopping offset value from among a plurality of second hopping offset values.

A twentieth aspect includes any of the first through nineteenth aspects, and further includes wherein a downlink control information (DCI) transmitted by the wireless access node indicates a resource type of a scheduled channel transmission.

A twenty-first aspect includes the twentieth aspects, and further includes wherein the scheduled channel transmission comprises a physical downlink shared channel (PDSCH), a physical uplink control channel (PUCCH), or the PUSCH.

A twenty-second aspect includes the twentieth aspect, and further includes wherein the resource type includes the UL BWP, wherein the scheduled channel transmission is transmitted on the UL BWP, or the resource type includes UL sub-band, wherein the scheduled channel transmission is transmitted on the UL sub-band.

A twenty-third aspect includes any of the first or second aspects, and further includes wherein determining the frequency hopping offset value or the frequency resource for the PUSCH based on at least one of the first frequency range or the second frequency range comprises: determining, with the wireless access node, the frequency resource for the PUSCH based on the first frequency range or the second frequency range according to a size comparison between the first frequency range and the second frequency range.

A twenty-fourth aspect includes the twenty-third aspect, and further includes wherein determining the frequency resource based on the first frequency range or the second frequency range according to the size comparison comprises: determining the frequency resource based on the first frequency range in response to the size comparison indicating that the first frequency range is larger than the second frequency range, or that the first frequency range completely covers the second frequency range; and determining the frequency resource based on the second frequency range in response to the size comparison indicating that the second frequency range is larger than the first frequency range, or that the second frequency range completely covers the first frequency range.

A twenty-fifth aspect includes any of the first or second aspects, and further includes wherein the PUSCH comprises a configured grant PUSCH or a plurality of PUSCH repetitions, the method further comprising: dropping, with the user device, the configured grant PUSCH or a PUSCH repetition of the plurality of PUSCH repetitions in response to the frequency resource of the configured grant PUSCH or the PUSCH repetition being out of the UL BWP or the UL sub-band.

A twenty-sixth aspect includes the twenty-fifth aspect, and further includes: determining, with the user device, not to count the dropped PUSCH repetition in a number of the plurality of PUSCH repetitions configured by the wireless access node.

A twenty-seventh aspect includes any of the first or second aspects, and further includes wherein the frequency resource for the PUSCH is scaled based on the first frequency range for the UL BWP and the second frequency range for the UL sub-band.

A twenty-eighth aspect includes a wireless communications apparatus comprising a processor and a memory, wherein the processor is configured to read code from the memory to implement any of the first through twenty-seventh aspects.

A twenty-ninth aspect includes a computer program product comprising a computer-readable program medium comprising code stored thereupon, the code, when executed by a processor, causing the processor to implement any of the first through twenty-seventh aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
determining, with a wireless access node, a first frequency range for an uplink (UL) bandwidth part (BWP), and a second frequency range for an UL sub-band;
determining, with the wireless access node, a frequency hopping offset value or a frequency resource for a physical uplink shared channel (PUSCH) based on at least one of the first frequency range or the second frequency range; and
receiving, with the wireless access node, the physical uplink shared channel (PUSCH) on the UL BWP or on the UL sub-band.

2. A method for wireless communication, the method comprising:
determining, with a user device, a first frequency range for an uplink (UL) bandwidth part (BWP), and a second frequency range for an UL sub-band;
determining, with the user device, a frequency hopping offset value or a frequency resource for a physical uplink shared channel (PUSCH) based on at least one of the first frequency range or the second frequency range; and
transmitting, with the user device, the PUSCH on the UL BWP or on the UL sub-band.

3. The method of claim 1, further comprising:
determining, with the wireless access node, a first configuration for the first frequency range and a second configuration for the second frequency range, wherein the first configuration and the second configuration each comprise at least one of: a frequency hopping method, a resource block group (RBG) size, or a plurality of frequency hopping offset values.

4. The method of claim 3, wherein the frequency hopping method comprises: no hopping, intra-slot hopping, or inter-slot hopping.

5. The method of claim 4, wherein the frequency hopping methods for the first configuration and the second configuration are the same.

6. The method of claim 4, wherein the frequency hopping methods for the first configuration and the second configuration are different.

7. The method of claim 1, wherein determining the frequency hopping offset value or the frequency resource for the PUSCH comprises at least one of:
determining, with the wireless access node, the hopping offset value from among a plurality of first hopping offset values for the PUSCH when the PUSCH is transmitted on the UL BWP; or
determining, with the wireless access node, the hopping offset value from among a plurality of second hopping offset values for the PUSCH when the PUSCH is transmitted on the UL sub-band.

8. The method of claim 1, wherein determining the frequency hopping offset value or the frequency resource for the PUSCH comprises at least one of:
determining, with the wireless access node, a first frequency resource for the PUSCH for when the PUSCH is transmitted on the UL BWP based on the first frequency range; or
determining, with the wireless access node, a second frequency resource for the PUSCH for when the PUSCH is transmitted on the UL sub-band based on the second frequency range.

9. The method of claim 1, wherein a downlink control information (DCI) comprises a frequency domain resource allocation (FDRA) field that indicates the frequency resource for the PUSCH.

10. The method of claim 9, wherein a length of the FDRA field depends on a first number of frequency resources of the UL BWP, on a second number of frequency resources of the UL sub-band, or on a larger of the first number of frequency resources and the second number of frequency resources.

11. The method of claim 9, wherein at least one of:
a first or last L1-number of bits of the FDRA field indicates the frequency resource for the PUSCH when the PUSCH is transmitted on the UL BWP; or
a first or last L2-number of bits of the FDRA field indicates the frequency resource for the PUSCH for when the PUSCH is transmitted on the UL sub-band.

12. The method of claim 9, wherein the FDRA field further indicates the frequency hopping offset value from among a plurality of first hopping offset values or from among a plurality of second hopping offset values.

13. The method of claim 12, wherein the FDRA comprises one bit configured to indicate the frequency hopping offset value from among the plurality of first hopping offset values or the plurality of second hopping offset values.

14. The method of claim 13, wherein the frequency offset value is a from among a first or last two hopping offset values of the plurality of first hopping offset values, or from among a first or last two hopping offset values of the plurality of second hopping offset values.

15. The method of claim 12, wherein the FDRA comprises two bits, wherein the two bits are configured to indicate the frequency hopping offset value from among a first or last two hopping offset values of the plurality of first hopping offset values, or from among a first or last two hopping offset values of the plurality of second hopping offset values, wherein one of the first bit or the second bit of the two bits indicates the frequency hopping offset value.

16. The method of claim 12, wherein the FDRA comprises two bits, wherein the two bits are configured to indicate the frequency hopping offset value from among a first or last three or four hopping offset values of the plurality of first hopping offset values, or from among a first or last three or four hopping offset values of the plurality of second hopping offset values.

17. The method of claim 9, wherein the FDRA field indicates no frequency hopping offset value, and a predetermined frequency hopping offset value is used in response to the FDRA field indicating no frequency hopping offset value.

18. The method of claim 9, wherein at least one of:
a first L1-number of bits of the FDRA field, after one or two bits that indicates the frequency hopping offset value, indicates the frequency resource for the PUSCH when the PUSCH is transmitted on the UL BWP; or
a first L2-number of bits of the FDRA field, after the one or two bits that indicates the frequency hopping offset value, indicates the frequency resource for the PUSCH when the PUSCH is transmitted on the UL sub-band.

19. The method of claim 9, wherein the frequency hopping offset value comprises a first frequency hopping offset value for transmission on the UL BWP and a second hopping offset value for transmission on the UL sub-band, wherein the FDRA field comprises a code point that indicates the first frequency hopping offset value from the among a plurality of first hopping offset values and the second frequency hopping offset value from among a plurality of second hopping offset values.

20. The method of claim 1, wherein a downlink control information (DCI) transmitted by the wireless access node indicates a resource type of a scheduled channel transmission.
